(19) United States
(12) Patent Application Publication
(10) Pub. No.: US 2025/0124926 A1
(43) Pub. Date: Apr. 17, 2025

(54) SILENT SPEECH INTERFACE UTILIZING MAGNETIC TONGUE MOTION TRACKING

(71) Applicant: Board of Regents, The University of Texas System, Austin, TX (US)

(72) Inventors: Jun Wang, Austin, TX (US); Beiming Cao, Sunnyvale, CA (US)

(21) Appl. No.: 18/918,338

(22) Filed: Oct. 17, 2024

Related U.S. Application Data
(60) Provisional application No. 63/590,906, filed on Oct. 17, 2023.

(51) Int. Cl. G10L 15/25; G10L 13/027; G10L 13/047; G10L 13/06; G10L 15/16

(52) U.S. Cl. CPC G10L 15/25; G10L 13/027; G10L 13/047; G10L 13/06; G10L 15/16

(57) ABSTRACT

A system for generating synthesized sound or speech includes at least one sensor positioned on the tongue of a user to generate position data and orientation data associated with a position and orientation of the tongue. The generated position data and orientation data from the sensor is used to generate, via an articulation conversion model, synthesizable sound or speech data using the generated position data and orientation data, which can be output as audio of synthesized voice or speech or a textual representation of the synthesizable sound or speech data.

### CROSS-REFERENCE TO RELATED APPLICATIONS

This application claims priority to and the benefit of U.S. Provisional Application No. 63/590,906, titled “SILENT SPEECH INTERFACE UTILIZING MAGNETIC TONGUE MOTION TRACKING”, filed on Oct. 17, 2023, the content of which is hereby incorporated by reference herein in its entirety.

### STATEMENT REGARDING FEDERALLY SPONSORED RESEARCH OR DEVELOPMENT

This invention was made with government support under Grant numbers R01 DC016621 and R03 DC013990 awarded by the National Institutes of Health. The government has certain rights in the invention.

### BACKGROUND

Silent speech interfaces (SSIs) are devices that convert articulation movement to speech and have the potential of recovering the speech ability for people who lost their voice but can still articulate, such as laryngectomees or individuals with aphonia. SSIs can also be used by healthy speakers who would like to communicate silently for privacy or security reasons. Laryngectomees are individuals who have their larynx surgically removed due to the treatment of cancer. Without their larynx, laryngectomees are unable to produce speech sounds. Laryngectomees currently use three types of speech modes in their daily communication (called alaryngeal speech): electrolarynx, tracheoesophageal puncture speech, and esophageal speech. Electrolarynx speech relies on a battery-powered, external electro-mechanical device that produces either pharyngeal or oral cavity vibrations. Tracheoesophageal puncture speech requires an additional surgery that makes a one-way valve from the trachea to the esophagus, which allows airflow from the trachea to drive the vibration of the throat wall. Esophageal speech involves ingesting air into the esophagus and then expel-ling it to drive throat wall vibration to produce sound. Alaryngeal speech typically results in an unnatural-sounding voice (e.g., extremely hoarse, or robotic), which discourages speakers' willingness to communicate and often results in social isolation and depression.

Although the articulation patterns of laryngectomees are different from those of healthy speakers (e.g., longer duration and more lateral movement), their patterns are consistent in producing the same speech. SSIs have been recently demonstrated to be able to generate more natural-sounding voice for laryngectomees. Several articulation tracking devices for SSI have been developed and used. These devices include electro-magnetic articulograph (EMA), permanent magnetic articulograph, surface electromyography, and ultra-sound imaging. However, key challenge for SSI development remains: to track the tongue motion patterns during speech using wearable devices suitable for daily use. Currently available devices, such as EMAs, are limited to laboratory use to their size, complexity, and cost.

### SUMMARY

One implementation of the present disclosure is a system for generating synthesized sound or speech, the system including: a sensor positioned on the tongue of a user to generate position data and orientation data associated with a position and orientation of the tongue; one or more processors; and memory having instructions stored thereon that, when executed by the one or more processors, cause the system to: receive the generated position data and orientation data from the sensor; generate, via an articulation conversion model, synthesizable sound or speech data using the generated position data and orientation data; and output the synthesizable sound or speech data as at least one of: (i) audio of synthesized voice or speech, or (ii) a textual representation of the synthesizable sound or speech data.

Another implementation of the present disclosure is a method for generating synthesized sound or speech, the method including: obtaining, from a sensor positioned on the tongue of a user, position data and orientation data associated with a position and orientation of the tongue, generating, via an articulation conversion model, synthesizable sound or speech data using the generated position data and orientation data; and outputting the synthesizable sound or speech data as at least one of: (i) audio of synthesized voice or speech, or (ii) a textual representation of the synthesizable sound or speech data.

In some implementations, generating the synthesizable sound or speech data includes to: generate phoneme data from the generated position data and orientation data; and convert the phoneme data to the synthesizable sound or speech data.

In some implementations generating the synthesizable sound or speech data includes to: generate text associated with sound or speech from the generated position data and orientation data; and convert the text to the synthesizable sound or speech data using a text-to-speech conversion model.

In some implementations, the output synthesizable sound or speech data is generated using a model (e.g., articulation conversion model and/or text-to-speech converter) that is trained using recorded speech obtained from the user (e.g., patient) and/or one or more other target individuals (e.g., a relative, a sibling).

In some implementations, the articulation conversion model includes a Gaussian mixture model (GMM) combined with a hidden Markov model (HMM).

In some implementations, the articulation conversion model includes a deep neural network (DNN) combined with a hidden Markov model (HMM).

In some implementations, the articulation conversion model includes a long short-term memory (LSTM) recurrent neural network (RNN).

In some implementations, the position data includes left-right (x), superior-inferior (y), and anterior-posterior (z) coordinates.

In some implementations, the orientation data includes pitch and roll.

In some implementations, the sensor includes an inertial measurement unit (IMU), wherein the position data is three-dimensional and the generated orientation data is two-dimensional.

In some implementations, the sensor is further configured to generate three-dimensional (3D) magnetic signals based on detected variations in a local magnetic field corresponding to movement of the tongue. In some such implementations, the instructions cause the system to and/or the method includes to: convert the 3D magnetic signals into additional 3D position information and additional 2D orientation information; and augment the position data and the orientation data with the additional 3D position information and the additional 2D orientation information for generating the synthesizable sound or speech data.

In some implementations, a pair of second sensors positioned on the lips of the user are used to generate lip movement data by tracking movement of the lips. In some such implementations, the instructions cause the system to and/or the method includes to: receive the lip movement data from the pair of second sensors, and wherein the synthesizable sound or speech data is generated using lip movement data in addition to the generated position data and orientation data.

Additional features will be set forth in part in the description which follows or may be learned by practice. The features will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a block diagram of a system for generating synthesizable sound or speech from motion data, according to some implementations.

FIGS. 2A-2C are diagrams of various motion-to-synthesizable sound or speech pipelines, according to some implementations.

FIG. 3 is a flow chart of a process for converting articulation movement into synthesizable speech and/or sound, according to some implementations.

FIG. 4 is a flow chart of another process for converting articulation movement into synthesizable speech and/or sound, according to some implementations.

FIG. 5 is a flow chart of yet another process for converting articulation movement into synthesizable speech and/or sound, according to some implementations.

FIGS. 6A-6D are diagrams of example systems including sensors that are configured to be positioned on the tongue and/or lips of a subject, according to some implementations.

FIG. 7 is an example user interface that can be displayed to illustrate motion of the tongue in different planes, according to some implementations.

FIG. 8 is a graph of example raw magnetic signals detected by a tongue sensor when a subject speaks a phrase, according to some implementations.

FIGS. 9A-9D are graphs of example tongue motion trajectories before and after dynamic time warping alignment, according to some implementations.

FIG. 10 is a graph that compares the accuracy of the disclosed system using various combinations of tongue and lip sensors, according to some implementations.

FIG. 11 is a graph of phoneme error rates in two subjects during silent speech recognition experiments, according to some implementations.

FIG. 12 is a graph comparing phoneme error rates during silent speech recognition experiments between the disclosed system and a commercial electromagnetic articulograph (EMA), according to some implementations.

FIG. 13 is a diagram of a tongue-teeth contact detection experiment, according to some implementations.

Various objects, aspects, and features of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a system and methods for converting articulation movement (e.g., movement of the tongue and/or lips) into synthesizable speech and/or sound—also referred to herein as a “silent speech interface (SSI) system”—are shown, according to various implementations. In particular, the disclosed system can include a controller that obtains articulation movement data from one or more sensors positioned on the tongue of a subject and then converts the articulation movement data into synthesizable speech and/or sound, which can be output as audio or text. The one or more sensors can include miniaturized inertial measurement units (IMUs) for determining a three-dimensional (3D) position and/or two-dimensional (2D) orientation of the subject's tongue. Optionally, the system may also include sensors positioned on the subject's lips which can provide additional information for generating synthesizable speech and/or sound. Additionally, or alternatively, in some implementations, raw magnetic field strength signals associated with the magnetometers in one or more tongue/lip sensors can be converted into and/or used as complementary information on top of the above-mentioned 3D position and/or 2D orientation data information.

Additionally, embodiments of the present disclosure provide methods for training a model to output audio or speech that matches a patient's presurgical voice, another individual's voice, or a target voice from a voice bank. The example model can be trained using both articulatory and audio data from a typical/target speaker or audio data from a single source/speaker (e.g., a relative, a sibling, the patient's historical audio data).

Compared to commercial EMA devices, the disclosed system is notably lightweight and, in some cases, wearable. For example, as mentioned above, commercial EMA devices are generally extremely bulky and are therefore not suitable for use outside of a laboratory or clinical setting. Further to this point, the disclosed system is generally much less complex, and thereby easier and cheaper to fabricate, making the overall cost of the system much more affordable to everyday users. In addition, the disclosed system is generally much easier to set up and use than commercial EMA devices, particularly for non-expert users. Additional details and features of the disclosed system and methods are described in greater detail below.

### Tongue Measurement and Articulation Conversion System

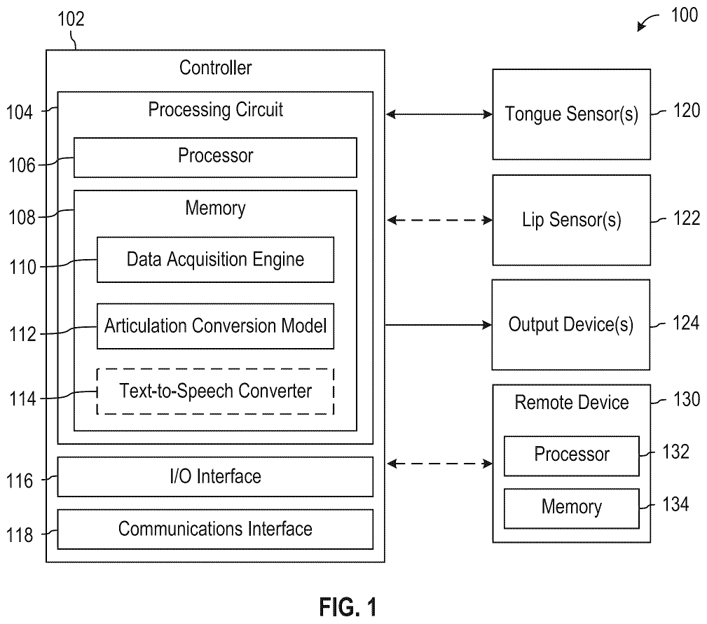

Referring first to FIG. 1, a block diagram of a system 100 for generating synthesizable sound or speech from motion data is shown, according to some implementations. Specifically, as mentioned above, one function of system 100 is to convert articulatory movement—or movement of the tongue and/or lips-into synthesizable speech and/or sound. That is, system 100 can generate representations of sound or speech (e.g., acoustic features) that can be synthesized and output as audible sound (or text, in some cases) that can be perceived by an average listener as speech. Thus, in at least one aspect, system 100 can be used to produced synthetic speech for users that are unable to speak (e.g., laryngectomees). It should also be appreciated, however, that system 100 can also be used for basic and clinical speech kinematic studies, visualization-based speech therapies, second language learning, and many other applications.

Broadly, system 100 is shown to include a controller 102 which processes data from tongue sensor(s) 120 and/or lip sensor(s) 122 to produce synthesizable speech and/or sound, which can then be output (e.g., via an output device 124) as text or sound. It should be noted that, generally, system 100 utilizes at least data obtained from tongue sensor(s) 120 to produce synthesizable speech and/or sound, as described in detail below. As such, lip sensor(s) 122 may be optional, in some implementations. As described herein, tongue sensor(s) 120 are generally miniaturized (e.g., below 6×6×0.8 mm³ in size, though this is not limiting) inertial measurement units (IMUs) capable of detecting movement of the tongue and lips of a user. Tongue sensor(s) 120 are configured to generate three-dimensional (3D) position and/or two-dimensional (2D) orientation data indicative of the position and/or orientation of the tongue (e.g., using one or more accelerometers and/or gyroscopes). In some implementations, for example, the 3D position and 2D orientation data are generated with respect to a reference position of the tongue (e.g., the tongue at rest). In some implementations, tongue sensor(s) 120 are also configured to detect variations in a local magnetic field (e.g., using a magnetometer) as the tongue moves. These magnetic field variations may be captured as raw 3D magnetic signals, which in turn can be used to augment the 3D position and 2D orientation data otherwise captured by tongue sensor(s) 120. For example, as discussed below, the raw 3D magnetic signals may be converted into 3D position and 2D orientation data which is then combined with, or otherwise used to improve, the 3D position and 2D orientation data obtained by the accelerometer and/or gyroscopic elements of the sensors. To this point, tongue sensor(s) 120 may be the same as, or functionally equivalent to, the sensors described in International Pat. App. No. WO 2022/147516 A1, filed on Jan. 4, 2022, which is incorporated herein by reference in its entirety.

Likewise, lip sensor(s) 122 may also be or may include IMUs. Lip sensor(s) 122 can capture 3D position and/or 2D orientation data indicative of movement of the user's lips. As described herein, 3D position data generally includes left-right (x), superior-inferior (y), and anterior-posterior (z) coordinates of tongue sensor(s) 120 and/or lip sensor(s) 122, e.g., with respect to a reference position. The 2D orientation data generally includes pitch and roll measurements. In some implementations, lip sensor(s) 122 are also configured to detect variations in a local magnetic field (e.g., using a magnetometer) as the lips move. Like the magnetic field variations detected by tongue sensor(s) 120, the magnetic field variations detected by sensor(s) 122 may be captured as raw 3D magnetic signals, which in turn can be used to enhance the 3D position and 2D orientation data otherwise captured by tongue sensor(s) 120 and/or lip sensor(s) 122. To this point, lip sensor(s) 122 may also be the same as, or functionally equivalent to, the sensors described in the '516 application mentioned above.

As generally described herein, system 100 may include at least one tongue sensor(s) 120 that is positioned on and/or attached to the tongue of a user; however, in various implementations, tongue sensor(s) 120 can include multiple sensors. In some implementations, the sensor is positioned at or near the tip of the user's tongue (e.g., within about 1 cm of the tip of the tongue). In some implementations, tongue sensor(s) 120 can include additional sensors positioned on the tongue other than at or near the tip of the tongue or in addition to the at least one sensor referenced above. For example, tongue sensor(s) 120 could include one sensor positioned at or near the tip of the tongue and another sensor positioned farther back on the tongue, e.g., closer to the user's throat. Likewise, lip sensor(s) 122 can include at least one sensor positioned on and/or attached to the lips of the user. More commonly, lip sensor(s) 122 include at least two sensors-one positioned on each of the top lip and the bottom lip of the user.

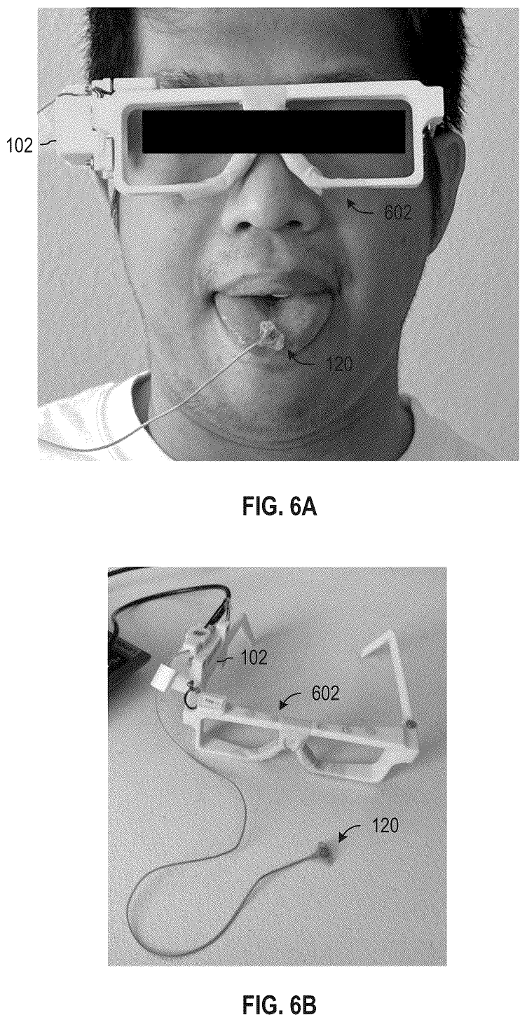

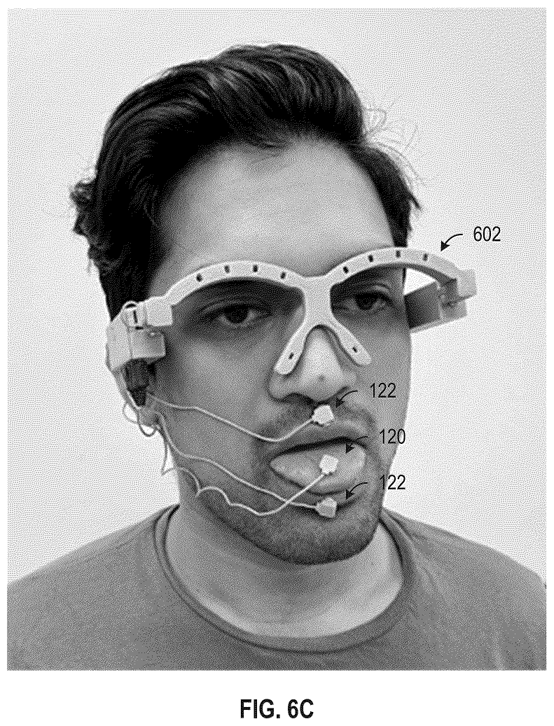

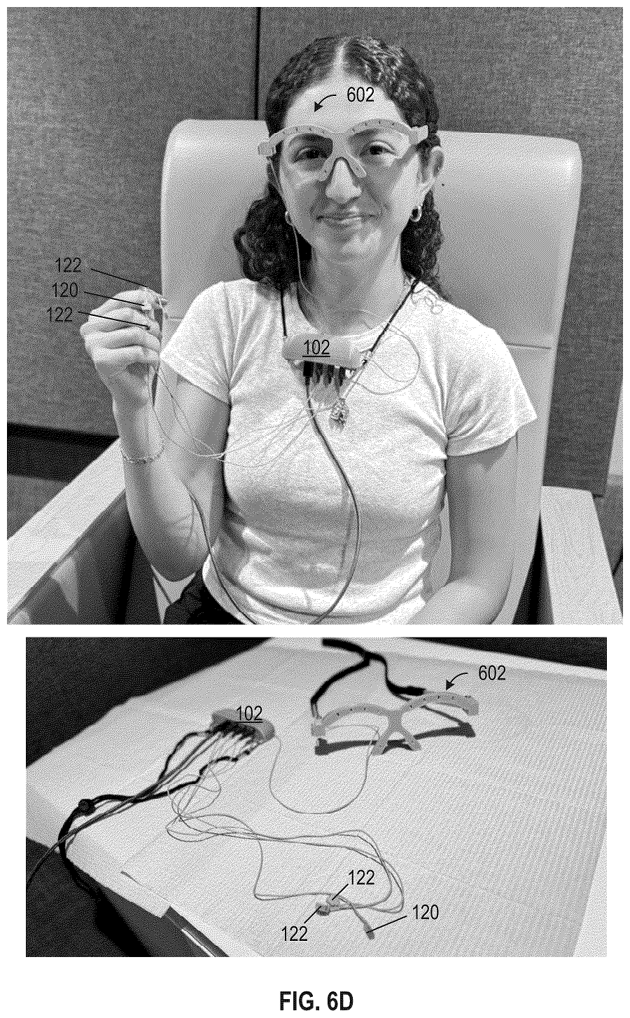

Additional reference is made herein to FIGS. 6A-6D, which illustrate example configurations of system 602 (also shown as system 100 in FIG. 1) which show example placement of tongue sensor(s) 120 and/or lip sensor(s) 122. For example, FIG. 6A shows a tongue sensor 120 positioned on a subject's tongue, near the tip, and FIG. 6C shows another configuration that includes lip sensor(s) 122. It should be appreciated that the present disclosure is not limiting with respect to the method or technique used to attach tongue sensor(s) 120 and/or lip sensor(s) 122 to the tongue or lips. For example, tongue sensor(s) 120 and lip sensor(s) 122 may be attached to the surface of the tongue and lips, respectively, with a suitable adhesive (e.g., dental glue) or may be surgically implanted.

As mentioned above, controller 102 is generally configured to receive signals from tongue sensor(s) 120 and lip sensor(s) 122 for the purposes of generating synthesizable speech and/or sound. A more detailed description of the functionality of controller 102 is provided below. Notably, controller 102 is generally configured to be worn or carried by a user and therefore is designed to be small and lightweight. With additional reference to FIGS. 6A-6D, for example, controller 102 may be contained within or attached to a pair of eyeglasses—or, rather, a housing in the shape of a pair of eyeglasses—that can be worn by the user. In another example, controller 102 may be contained in a housing that can be attached to a user's clothing, worn as a necklace or headband, or the like. In this regard, while not shown, controller 102 may also include a power supply, such as a battery, such that controller 102 is portable. In some implementations, the housing (e.g., in the form of a pair of eyeglasses) may also contain one or more permanent magnets for generating a local magnetic field.

In FIG. 6B, for example, a row of magnets is shown to be incorporated into a top portion of the eyeglass frame. However, the present disclosure is not intended to be limiting with respect to the specific shape, size, or configuration of the housing for controller 102 or for the attachment of permanent magnetics to generate a local magnetic field; rather, most importantly, controller 102 is small enough to be carried by the user, unlike existing EMA devices. Additionally, magnets may be otherwise incorporated into system 60200 for generating the magnetic field and/or other techniques for generating a magnetic field may be used.

FIG. 6D illustrates an example configuration in which the controller 102 is separate from (e.g., remote from) the eyeglasses. As shown, the controller 102 is configured as or forms part of a necklace that is worn around a subject's neck. In various implementations, the controller 102/necklace is in electronic communication with the eyeglasses and/or other sensors (120, 122) of the system 602 via wired and/or wireless connections. In various examples, the system can be fully or partially wireless. Alternatively, the controller 102 can be configured as a headband, hat, brooch, pin, or the like. In some implementations, the controller 102 can be embodied as or be part of a user device (e.g., mobile device, tablet) and is controllable/configurable via an App executing on the user device.

Referring again to FIG. 1, controller 102 is shown to include a processing circuit 104 that includes a processor 106 and a memory 108. Processor 106 can be a general-purpose processor, an application specific integrated circuit (ASIC), one or more field programmable gate arrays (FPGAs), a group of processing components (e.g., a central processing unit (CPU)), or other suitable electronic processing structures. In some implementations, processor 106 is configured to execute program code stored on memory 108 to cause controller 102 to perform one or more operations, as described below in greater detail. While shown as a separate device, it will be appreciated that controller 102 and/or certain functionalities thereof may be part of another computing device. In some such implementations, the components of controller 102 may be shared with, or the same as, the host device. For example, if controller 102 is implemented via a laptop computer, then controller 102 may utilize the processing circuit, processor(s), and/or memory of the laptop computer to perform the functions described herein. Additional discussion is provided below.

Memory 108 can include one or more devices (e.g., memory units, memory devices, storage devices, etc.) for storing data and/or computer code for completing and/or facilitating the various processes described in the present disclosure. In some implementations, memory 108 includes tangible (e.g., non-transitory), computer-readable media that stores code or instructions executable by processor 106. Tangible, computer-readable media refers to any physical media that is capable of providing data that causes controller 102 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 108 can include random access memory (RAM), read-only memory (ROM), erasable programmable read-only memory (EPROM), electronically erasable programmable read-only memory (EEPROM), hard drive storage, temporary storage, non-volatile memory, flash memory, optical memory, or any other suitable memory for storing software objects and/or computer instructions. Memory 108 can include database components, object code components, script components, or any other type of information structure for supporting the various activities and information structures described in the present disclosure. Memory 108 can be communicably connected to processor 106, such as via processing circuit 104, and can include computer code for executing (e.g., by processor 106) one or more processes described herein.

While shown as individual components, it will be appreciated that processor 106 and/or memory 108 can be implemented using a variety of different types and quantities of processors and memory. For example, processor 106 may represent a single processing device or multiple processing devices. Similarly, memory 108 may represent a single memory device or multiple memory devices. Additionally, in some implementations, controller 102 may be implemented within a single computing device (e.g., in one housing, etc.). In other implementations, controller 102 may be distributed across multiple computing device (e.g., that can exist in distributed locations). For example, controller 102 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers.

Memory 108 is shown to include a data acquisition engine 110 configured to intake and preprocess the articulation data (e.g., positional, orientational, and/or magnetic data) obtained from tongue sensor(s) 120 and/or lip sensor(s) 122. Specifically, data acquisition engine 110 receives 3D position and/or 2D orientation data from one or both of tongue sensor(s) 120 and/or lip sensor(s) 122 and, if needed, can preprocess the data, e.g., to remove artifacts or noise, to normalize the data, etc. To this point, in some implementations, data acquisition engine 110 can also set a reference point for the 3D position and/or 2D orientation data. For example, data acquisition engine 110 can be used to initially calibrate tongue sensor(s) 120 and/or lip sensor(s) 122 to a reference position (e.g., the origin in a 2D or 3D space), e.g., when the user's tongue is in a resting position. While generally described herein as generating the 3D position and/or 2D orientation data themselves, in certain other implementations, tongue sensor(s) 120 and/or lip sensor(s) can instead send raw IMU signal data to 102, e.g., without any processing. In some such implementations, data acquisition engine 110 may also be configured to convert raw signals from tongue sensor(s) 120 and/or lip sensor(s) into the 3D position and/or 2D orientation data described herein.

In some implementations, when magnetic field variation data is also collected by tongue sensor(s) 120 and/or lip sensor(s) 122, e.g., in the form of raw magnetic signals, data acquisition engine 110 can also be configured to convert the raw magnetic signals into 3D position and/or 2D orientation data. Then, the additional 3D position and/or 2D orientation data generated from the magnetic signals can be augmented with the 3D position and/or 2D orientation data otherwise reported by tongue sensor(s) 120 and/or lip sensor(s) 122, e.g., to improve fidelity. In some such implementations, the 3D position and/or 2D orientation data generated from the magnetic signals and the 3D position and/or 2D orientation data otherwise reported by tongue sensor(s) 120 and/or lip sensor(s) are combined to generate aggregate 3D position and/or 2D orientation data. In other implementations, the 3D position and/or 2D orientation data generated from the magnetic signals is kept separate from the 3D position and/or 2D orientation data otherwise reported by tongue sensor(s) 120 and/or lip sensor(s) 122 for further processing, as described below. In some implementations, data acquisition engine 110 can also include or utilize a digital low-pass filter for pre-processing the articulation data (e.g., the position, orientation, and/or magnetic data) to reduce or remove noise.

Memory 108 is also shown to include an articulation conversion model 112 that is generally configured to convert motion data (e.g., articulation data recorded by tongue sensor(s) 120 and/or lip sensor(s) 122, as discussed above) into synthesizable sound or speech data. As described herein, “synthesizable sound or speech data” generally refers to data (e.g., of various formats) that can be perceived by an average listener as speech, e.g., when synthesized into audio, and/or converted that can be perceived as written language when converted into text. For example, synthesizable sound or speech data may include a sequence of sounds that, when output via an audio device in a continuous manner, can be perceived as synthetic human speech. In another example, the synthesizable sound or speech data can be output as a string of readable words or phrases in the form of text. In some implementations, articulation conversion model 112 is, or can include, an artificial intelligence (AI) based model for performing this articulation-to-speech conversion, as discussed in greater detail below.

The term “artificial intelligence” is defined herein to include any technique that enables one or more computing devices or comping systems (e.g., a machine) to mimic human intelligence. AI includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural networks (ANNs) or multilayer perceptrons (MLPs).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

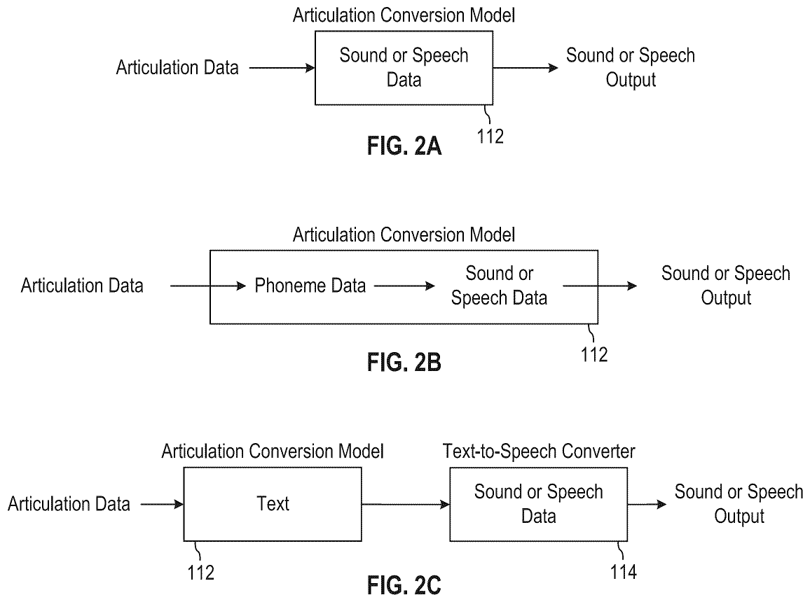

It should be appreciated that articulation conversion model 112 (e.g., an AI model) may be, or include, a single AI model or multiple different AI models, e.g., of the same or different types, depending on the implementation. Generally, articulation conversion model 112 is configured to convert frame-by-frame input (e.g., articulation information) into a representation of sounds that can be used to generate audible speech. In various implementations, the representations are acoustic features, phonemes in text form, or phonemes in numeric vectors. Articulation conversion model 112 can be categorized by traditional Hidden-Markov-Model (HMM) based approaches or newer end-to-end models (without using HMM). Further to this point, articulation conversion model 112 may process articulation data (e.g., motion data from data acquisition engine 110) in multiple different ways, as illustrated in FIGS. 2A-2C which are discussed in great detail below. In some implementations, for example, articulation conversion model 112 converts articulation data directly into synthesizable sound or speech (e.g., acoustic features). In other implementations, articulation conversion model 112 converts the articulation data first into a series of phonemes (e.g., in numeric vectors), which can then be converted into synthesizable sound or speech. In yet other implementations, articulation conversion model 112 converts the articulation data first into text (e.g., similar to a speech-to-text conversion), which can then be converted into synthesizable sound or speech using text-to-speech conversion techniques.

Motion-to-Speech: With respect to implementations in which articulation conversion model 112 is configured to convert articulation data directly into synthesizable sound or speech using an end-to-end model, additional reference is made herein to FIG. 2A which illustrates an example processing pipeline for said conversion. In some such implementations, articulation conversion model 112 can include a variation of an audio speech recognition model that has been adapted to accept a lower-dimension input (e.g., of articulation data) and to produce synthesizable sound or speech. In some implementations, for example, the articulation data is provided to articulation conversion model 112 as a 15-dimensional input vector as opposed to a 39-to-80-plus-dimensional input commonly utilized with audio speech recognition models. In some such implementations, articulation conversion model 112 obtains new input vectors periodically (e.g., every 10 ms) but articulation data may also be fed to articulation conversion model 112 continuously and then processed periodically.

In some motion-to-speech implementations, articulation conversion model 112 includes a Hidden Markov Model combined with a Deep Neural Network, referred to herein as an HMM-DNN model. In an HMM-DNN configuration, the HMM models temporal variations during speech, such as varying durations of the same phonemes. For example, a single phoneme would be represented by a three-state left-to-right HMM (begin-middle-end subphones) and the time variation of this phoneme would be modeled by intra- or interstate transition (e.g., stay in the same state or go to the next state). It should be appreciated that the number of states in the HMM is not limited herein. For example, the number of states could be more than three (e.g., five), which may be more suitable for slower speaking rates. The DNN models the probability distribution of the articulation data given the current phonemes. In other words, the DNN extracts features from the articulation data which are used by the HMM to determine state transitions. As an input, articulation conversion model 112 generally obtains frame-by-frame articulation information (e.g., the 3D position, 2D orientation, and/or magnetic field strength values of tongue sensor(s) 120 and/or lip sensor(s) 122). In some implementations, a “frame” of articulation information ranges from 15 ms to 25 ms; however, the present disclosure is not intended to be limiting in this regard. As mentioned above, an output of articulation conversion model 112 is the phoneme or sounds sequences.

In other motion-to-speech implementations, articulation conversion model 112 includes a convolutional neural network (CNN). A CNN typically includes multiple convolutional blocks for extracting features from the input of articulation information and then a fully-connected (FC) layer as the classifier. In yet other motion-to-speech implementations, articulation conversion model 112 includes a Hidden Markov Model combined with a Gaussian Mixture Model, referred to herein as an HMM-GMM model. In an HMM-GMM configuration, the HMM likewise models temporal variations during speech and the GMM models the probability distribution of the articulation data. In yet other motion-to-speech implementations, articulation conversion model 112 includes a long short-term memory recurrent neural network (LTSM-RNN). An LTSM-RNN generates acoustic features from the input articulation data vector. The acoustic features can then be passed to a vocoder for generation of a speech or sound waveform and/or can be used to generate text, as described in greater detail below. Thus, in some implementations, articulation conversion model 112 may include, or function as, a vocoder to extract acoustic features and generate a waveform for output. In other implementations, output device(s) 124 instead includes a vocoder.

In some implementations, regardless of the specific type of AI model implemented by articulation conversion model 112 for motion-to-speech conversion, articulation conversion model 112 is trained using training data that associates articulation data (e.g., captured using system 100) with speech or sound. For example, a training data set may be developed by having multiple different subjects audibly speak while utilizing system 100. An audio capturing device (e.g., a microphone) can then be used to capture the subject's speech/sounds in conjunction with the articulation data generated by system 100. In some implementations, subjects may be asked to speak a number of different predefined phrases, emit a series of predefined sounds, etc., or may just be asked to speak normally for an amount of time. In some implementations, after being captured, the audio and articulation data may be post-processed, e.g., by aligning or time-locking the audio data with the articulation data. It should be appreciated, however, that the specific technique for generating training data and/or training articulation conversion model 112 is not intended to be limited to the examples discussed herein. The training data set can also be used to generate output audio or speech data that is similar to a subject's natural speech or has target characteristics (e.g., fluency, prosody, pitch, loudness, or the like). The number of data sources used to generate a given training data set for a patient or group of patients may vary and can be limited to the subject(s) themselves or a subset of individuals (e.g., female or male voices). In other embodiments, the data sources can include one or more target individuals (e.g., relatives, individuals that speak with a particular accent, or the like).

In this manner, a training data set can be generated by associating speech or sounds with captured articulation data. In some implementations, in addition to or in lieu of having normally-speaking subjects generate the training data, one or more subjects having specific speech impairments may be utilized to augment the training data and/or to generate additional training data sets. In this way, articulation conversion model 112 may be trained to recognize speech in users that may not speak “normally.” Extending this idea, training data sets may also be generated from subjects that speak different languages such that articulation conversion model 112 can be used to generate synthesizable sound or speech data in multiple languages. For example, in a use-case, a user of system 100 may be able to select a specific language when utilizing system 100 to cause articulation conversion model 112 to use or retrieve a specific pre-trained model.

Motion-to-Phoneme-to-Speech: With respect to implementations in which articulation conversion model 112 is configured to convert articulation data into a series of phonemes before generating synthesizable sound or speech, additional reference is made herein to FIG. 2B which illustrates an example processing pipeline for said conversion. As described in greater detail below, those of skill in the art will understand that a phoneme generally references to the smallest units of speech that distinguish one word or word element from another (e.g., p, b, d, and t in the English words pad, pat, bad, and bat). Thus, in some such implementations, articulation conversion model 112 may be configured to identify phonemes from the articulation data.

As shown, in some such implementations, articulation conversion model 112 may have two components—a first component for converting input articulation data into phoneme data and a second component for converting the phoneme data into synthesizable sound or speech data. First, the input articulation data is converted into phoneme data represented using numeric 44-dimension vectors for all 44 phonemes (e.g., one-hot encoding, where 00001 represents “phoneme 1”, 00010 represents “phoneme 2”, and so on). Extra vectors can be used to describe other useful information for synthesis (e.g., is the current phoneme in the initial or middle or at the end of a word?). These vectors can then be converted into synthesizable sound or speech data, e.g., in the form of acoustic features, by the second (“synthesis”) component of articulation conversion model 112. In some implementations, the output of the “synthesis” component is acoustic features that can be directly converted into audible sounds, e.g., by a vocoder. In some implementations, this procedure is performed frame-by-frame, which means the conversion is real-time.

In some implementations, the “first component” of articulation conversion model 112 is referred as silent speech recognition, which may include, or utilize, any of the different types of model architecture mentioned above for motion-to-phoneme-to-speech conversions, including HMM-based or end-to-end models. The “second component” can be also implemented in HMM or non-HMM models. For example, motion-to-phoneme conversion can be achieved using an HMM-DNN model, an HMM-GMM model, an LTSM-RNN, or another suitable type of AI model. In one specific example, articulation conversion model 112 may include, or utilize, a type of classifier for classifying (e.g., assigning a class/label) articulation data as one of a plurality of predefined phonemes. In some implementations, articulation conversion model 112 may include, or function as, a vocoder to extract acoustic features and generate a waveform for output. In other implementations, output device(s) 124 instead includes a vocoder.

Much like in the motion-to-speech implementation described above, articulation conversion model 112 may be trained using training data that associates articulation data with a set of different, predefined phonemes. For example, the English language contains approximately 44 phonemes; thus, a training data set can be generated (e.g., using system 100) that associates these 44 phonemes with articulation data. In such an example, a subject or multiple subjects may be asked to reproduce each of the 44 phonemes while articulation data is captured using system 100, e.g., to generate the training data set. Then, the training data set can be used to train articulation conversion model 112 to convert articulation data into phonemes. From a series of phonemes, articulation conversion model 112 can generate synthesizable sound or speech data as mentioned above. It should be appreciated, however, that the specific technique for generating training data and/or training articulation conversion model 112 is not intended to be limited to the examples discussed herein.

Motion-to-Text-to-Speech: With respect to implementations in which articulation conversion model 112 is configured to convert articulation data into text before synthesizable sound or speech is generated, additional reference is made herein to FIG. 2C which illustrates an example processing pipeline for said conversion. Specifically, as shown, articulation conversion model 112 may first convert input articulation data into text, e.g., including letters, phonemes, or whole words. Then, the text may be converted into synthesizable sound or speech data using a text-to-speech converter 114 as described in greater detail below. Both the motion-to-text (e.g., articulation conversion model 112) and text-to-speech components (e.g., text-to-speech converter 114) may include, or utilize, any of the different types of model architecture mentioned above for motion-to-text or motion-to-phoneme conversion. For example, motion-to-text conversion can be achieved using an HMM-DNN model, an HMM-GMM model, an LTSM-RNN, or another suitable type of AI model. In one specific example, articulation conversion model 112 may include, or utilize, a type of classifier for classifying (e.g., assigning a class/label) articulation data as a known word or phrase. In other implementations, articulation conversion model 112 can be, or can include, a modified speech-to-text model for motion-to-text conversion. For example, articulation conversion model 112 can include a (spoken) language model or a natural language processing (NLP) model that utilizes context information to enhance the performance motion-to-text.

In this regard, much like in the motion-to-speech and motion-to-phoneme-to-speech implementations described above, articulation conversion model 112 may be trained using training data that associates articulation data with a preset of words or phrases. For example, a training data set can be generated (e.g., using system 100) that associates articulation data with known words or phrases. In some implementations, articulation data can be generated by one or more subjects that are asked to speak various words or phrases, and/or may be asked to emit certain sounds that are commonly used to form words (e.g., phonemes, as discussed above). Then, in some such implementations, the articulation data can be extrapolated for various words or phrases that were not explicitly spoken by the subjects. Alternatively, the training data set may be generated by asking subjects to emit phonemes (e.g., which tend to be limited in number across various languages) and recording articulation data. Then, the training data set can be used to train articulation conversion model 112 to convert articulation data into phonemes, and phonemes into text. It should be appreciated, however, that the specific technique for generating training data and/or training articulation conversion model 112 is not intended to be limited to the examples discussed herein.

In some implementations, articulation conversion model 112 can be trained based on audio data of multiple speakers, as opposed to being trained directly from articulation data. Often, more robust data sets are available for audio speech recognition (ASR) than for silent speech recognition (SSR). Specifically, in some such implementations, an ASR model (e.g., a CNN) is trained using speech data of a group of speakers (e.g., normal speakers or speakers with specific pathologies) in order to generate text of the speech. An initialized bidirectional-gate recurrent unit (Bi-GRU), which is a type of recurrent neural network or, more specifically, a three-layer GRU, is connected to the trained ASR model. Together, the ASR model and Bi-GRU form a “pseudo articulation-to-speech (ATS) model.” The pseudo ATS can then be used to convert articulation data from a user into text, which in turn can be converted into synthesizable sound or speech data. In some implementations, the pseudo ATS can be fine-tuned (e.g., retrained) with articulation data from the target user before or during use. In some such implementations, the pseudo ATS is retrained with one or more parameters of the trained ASR model frozen. In other such implementations, both the ASR model and the Bi-GRU are retrained together.

Text-to-speech converter 114, as mentioned above, is shown to be an optional component of memory 108, e.g., in implementation whether articulation conversion model 112 is configured/trained to convert articulation data to text instead of to phonemes or directly to speech. Text-to-speech converter 114 may be, or include, any machine learning model that is suitable for text-to-speech conversion, such as a deep learning model. Text-to-speech converter 114 is generally configured to extract linguistic features from the text generated by articulation conversion model 112, e.g., of speech or sound, and then convert the linguistic features to acoustic features. The acoustic features may then be used to generate a waveform which can be emitted as audio. In some implementations, the acoustic features are provided to a vocoder (e.g., part of text-to-speech converter 114) for generating a waveform.

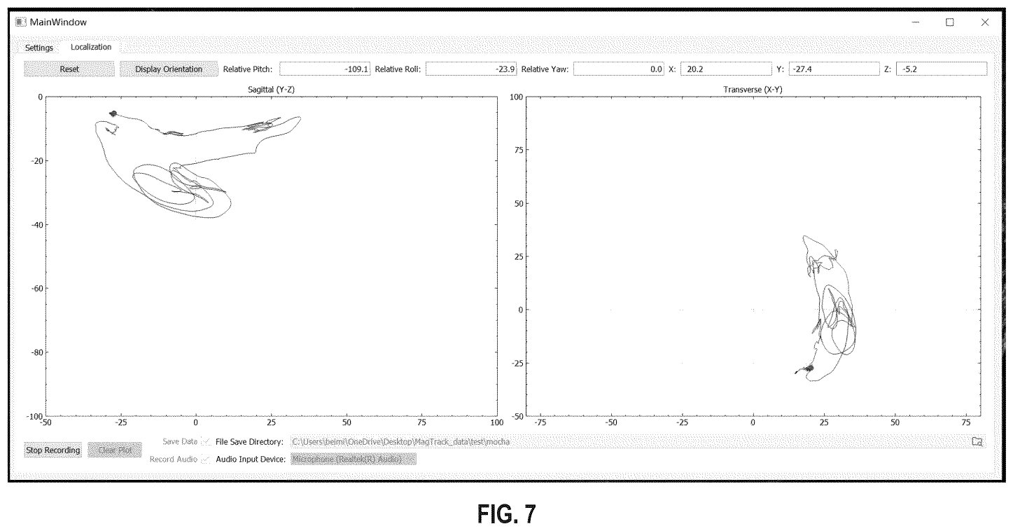

Once the synthesizable sound or speech data is generated, controller 102 may utilize output device(s) 124 to provide an audio output and/or to display a textual representation of the synthesizable sound or speech data. Thus, in some implementations, output device(s) 124 may include a speaker for outputting audio (e.g., as mentioned above, sound that is perceivable as speech). As mentioned above, in some implementations, output device(s) 124 (or articulation conversion model 112) can include a vocoder or other suitable components for generating a waveform from the synthesizable sound or speech data for audio output. In some implementations, output device(s) 124 can include a display or a device having a display for presenting a textual representation of the sound or speech. Additionally, or alternatively, controller 102 may be configured to generate and/or display (e.g., via output device(s) 124) a user interface that indicates any of the articulation data (e.g., the 3D position data, the 2D orientation data, and/or the magnetic data). In some such implementations, data acquisition engine 110 can be configured to output the raw or pre-processed data obtained from tongue sensor(s) 120 and/or lip sensor(s) 122, e.g., in addition to or in lieu of the synthesizable sound or speech generation performed by articulation conversion model 112. An example of one such user interface is shown in FIG. 7, where graphs of sagittal (y-z) and transverse (x-y) movement of tongue sensor(s) 120 are illustrated.

Still referring to FIG. 1, controller 102 is further shown to include an input/output (I/O) interface 116 for sending signals to and/or receiving signals from certain external components, such as tongue sensor(s) 120 and lip sensor(s) 122. Optionally, I/O interface 116 may also be used to send signals to output device(s) 124. In any case, I/O interface 116 can include any number of jacks, antennas, transmitters, receivers, transceivers, wire terminals, or other types of interfaces to facilitate said transmission/receipt of signals. For example, I/O interface 116 can include multiple jacks to which tongue sensor(s) 120 and/or lip sensor(s) 122 can be connected, e.g., via respective wires. In another example, I/O interface 116 may include a wireless transceiver for wireless communicating with tongue sensor(s) 120 and/or lip sensor(s) 122. In yet another example, I/O interface 116 may include a jack to which a display screen or speaker (e.g., one of output device(s) 124) can be connected. Thus, it should be appreciated that the specific configuration of I/O interface 116 is not limiting in this regard.

Controller 102 is also shown to include a communications interface 118 that facilitates communications between controller 102 and external computing devices, including a remote device 130 as described below. In other words, communications interface 118 can provide means for transmitting data to, or receiving data from, remote device 130 and/or other external computing devices. Accordingly, communications interface 118 can be or can include a wired or wireless communications interface (e.g., jacks, antennas, transmitters, receivers, transceivers, wire terminals, etc.) for conducting data communications, or a combination of wired and/or wireless communication interfaces. In this regard, it will be appreciated that communications interface 118 may also provide the functionality of I/O interface 116 in some implementations (e.g., I/O interface 116 and communications interface 118 may be part of the same component); however, the present disclosure is not limiting in this regard.

In some implementations, communications via communications interface 118 are direct (e.g., local wired or wireless communications) or via a network (e.g., a WAN, the Internet, a cellular network, etc.). For example, communications interface 118 may include one or more Ethernet ports for communicably coupling controller 102 to a network (e.g., the Internet). In another example, communications interface 118 can include a Wi-Fi transceiver and/or cellular or mobile phone communications transceivers for wireless communications. In yet another example, communications interface 118 includes a short-range wireless transceiver (e.g., a Bluetooth®) transceiver for short-range wireless communications to remote device 130.

Remote device 130 is any computing device that can interface with controller 102; in other words, that can communicate with controller 102. While shown as a single device, it should be appreciated that remote device 130 can include any number of different computing devices. Remote device 130 can include, for example, a mobile phone, an electronic tablet, a smartwatch, a laptop, or any other type of electronic device. In one specific example, remote device 130 is a smartphone. Generally, remote device 130 includes a processor 132 and memory 134 which are similar in structure and/or functionality to processor 106 and memory 108, as described above. In some implementations, remote device 130 also includes a user interface (not shown), such as a touchscreen, keyboard, mouse, etc., allowing a user to interact with controller 102 remotely. For example, remote device 130 may include a user interface that allows a user to view or change parameters/settings of controller 102, select operating modes, etc.

In some implementations, remote device 130 is wirelessly connected to controller 102, such as via a short-range wireless connection or via a network (e.g., the Internet), and therefore is remote/separate from controller 102. As mentioned above, for example, remote device 130 may be a smartphone that is carried by a user of controller 102 or, more broadly, system 100. In some implementations, remote device 130 is configured to perform at least some functions of controller 102 and/or output device(s) 124 as described herein. For example, in some implementations, controller 102 can be configured to simply collect data from tongue sensor(s) 120 and/or lip sensor(s) 122 and transmit the collected data to remote device 130, where it is processed via an articulation engine and/or speech recognizer (as described above). This can, in some cases, reduce the computational burden on controller 102, in turn allowing controller 102 to be configured with a less expensive and/or lower-power requirement processor. In implementations where controller 102 includes a battery, this can conserve battery life. In some implementations, remote device 130 can take the place of or perform certain functions of output device(s) 124. For example, instead of outputting synthesized speech or sound via a speaker directly, controller 102 may transmit the synthesized speech or sound to remote device 130 to utilize a speaker built into remote device 130. In another example, remote device 130 can include a display for presenting the synthesized speech or sound as text. In yet another example, remote device 130 is a cloud computing server accessible via the Internet. In some such implementations, remote device 130 may implement one of more of the machine learning models described herein.

### Method of Operation—Motion-to-Speech

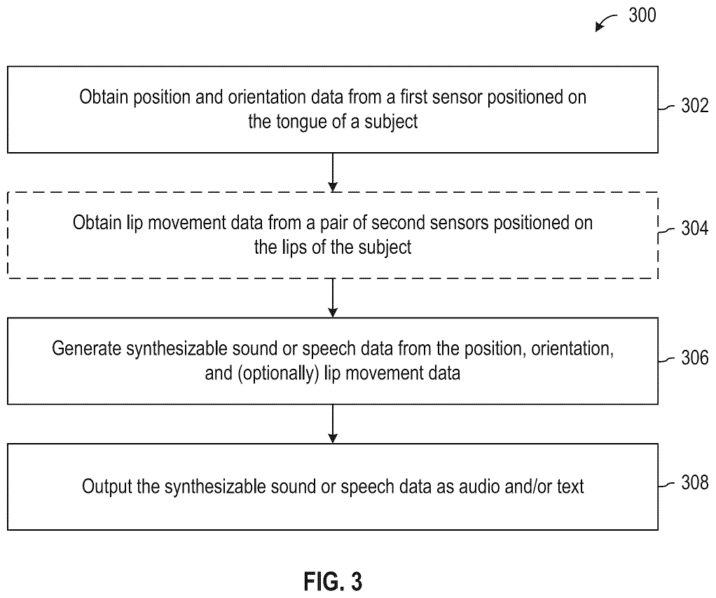

Referring now to FIG. 3, a flow chart of a process 300 for converting articulation data (e.g., tongue and/or lip motion) into synthesizable sound or speech is shown, according to some implementations. In particular, process 300 generally describes a technique of converting articulation data directly to synthesizable sound or speech, as discussed above. In this regard, process 300 can be implemented by system 100 and/or, more specifically, by controller 102 as described above. However, in some implementations, certain steps of process 300 are performed by an external device (e.g., remote device 130) upon receiving data from controller 102. It will be appreciated that certain steps of process 300 may be optional and, in some implementations, process 300 may be implemented using less than all of the steps. It will also be appreciated that the order of steps shown in FIG. 3 is not intended to be limiting.

At step 302, position and orientation data are obtained from a first sensor positioned on the tongue of a subject. As described above, the first sensor is one of tongue sensor(s) 120 that are generally positioned at or near (e.g., within 1 cm of) the tip of the subject's tongue. While implementations using only one sensor on the subject's tongue are generally described herein, it will be appreciated that the “first sensor” may refer to any number of sensors on the tongue. The first sensor is therefore configured to generate 3D position data (e.g., left-right (x), superior-inferior (y), and anterior-posterior (z) coordinates) and 2D orientation data (e.g., pitch and roll) indicative of movement of the subject's tongue. In some implementations, the first sensor is configured to generate the 3D position and 2D orientation data itself, which are provided to a separate computing device (e.g., controller 102). In other implementations, the first sensor provides raw data/signals to controller 102, which then generates the 3D position and 2D orientation.

Further, as mentioned above, the first sensor may be configured to detect variations in a local magnetic field as the tongue moves. For example, a local magnetic field in the vicinity of the subject's tongue may be generated by an arrangement of permanent magnets. Thus, when the first sensor (which is positioned on the tongue) moves through the local magnetic field, it may generate raw magnetic signals indicative of tongue movement. These magnetic signals may, in some implementations, be used to generate the 3D position and 2D orientation data, e.g., in conjunction with other data obtained by the first sensor (e.g., acceleration data). In some implementations, the raw magnetic signals are converted to 3D position and/or 2D orientation data which is used to enhance the 3D position and 2D orientation data generated using other components (e.g., accelerometers, gyroscopes) of the first sensor.

At step 304, lip movement data is optionally obtained from a pair of second sensors positioned on the lips of the subject. As described above, the pair of second sensors can be lip sensor(s) 122 that are positioned on the subject's lips (e.g., one on the top lip, the other on the bottom lip). Lip sensor(s) 122 are generally configured to also generate additional 3D position and/or 2D orientation data which is used in conjunction with the 3D position and/or 2D orientation data from the first sensor.

At step 306, synthesizable sound or speech data is generated from the position and orientation data, and optionally the lip movement data, which is collectively referred to herein as “articulation data.” In particular, the articulation data is provided as an input to an articulation conversion model (e.g., articulation conversion model 112, as described above), which outputs synthesizable sound or speech data, e.g., as acoustic features. As mentioned above, the articulation conversion model may include one of an HMM-DNN, HMM-GMM, LSTM-RNN, or other suitable AI model or combination of AI models. For example, the articulation conversion model may be a type of audio speech recognition model that has been adapted to accept articulation data as an input (e.g., which is typically a smaller number of dimensions than an audio input). Notably, in the specific implementation of process 300, the articulation conversion model is trained and/or configured to convert articulation data directly into synthesizable sound or speech data.

At step 308, the synthesizable sound or speech data is output as audio or text. Specifically, in some implementations, the synthesizable sound or speech data is used to generate an audio output that, when emitted by a speaker, is perceivable as speech. In some such implementations, a vocoder may be used to further convert the synthesizable sound or speech data to a waveform. In some implementations, the synthesizable sound or speech data is displayed as text, e.g., on a user interface. For example, the text could be displayed via the user's smartphone.

### Method of Operation—Motion-to-Phoneme-to-Speech

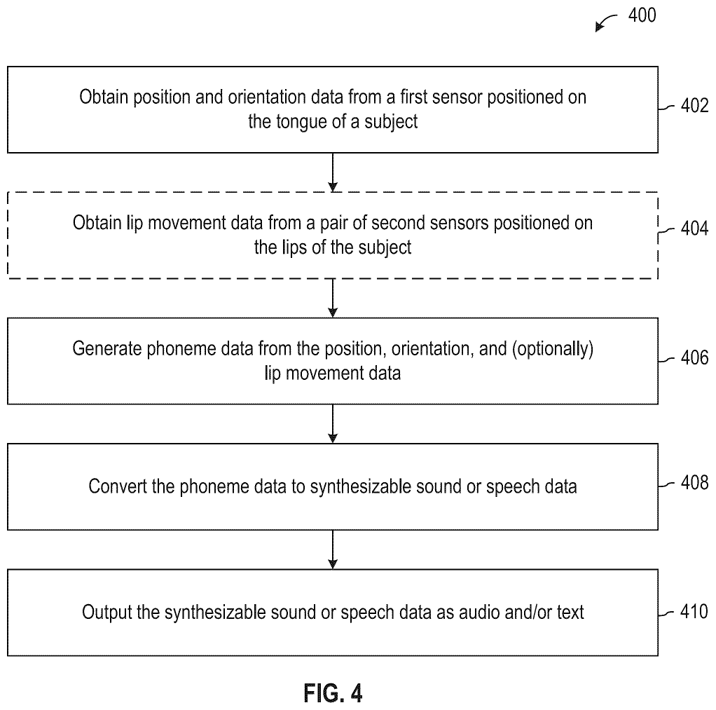

Referring now to FIG. 4, a flow chart of another process 400 for converting articulation data (e.g., tongue and/or lip motion) into synthesizable sound or speech is shown, according to some implementations. In particular, process 400 generally describes a technique of converting articulation data into a series of phonemes, and then into synthesizable sound or speech, as discussed above. In this regard, process 400 can be implemented by system 100 and/or, more specifically, by controller 102 as described above. However, in some implementations, certain steps of process 400 are performed by an external device (e.g., remote device 130) upon receiving data from controller 102. It will be appreciated that certain steps of process 400 may be optional and, in some implementations, process 400 may be implemented using less than all of the steps. It will also be appreciated that the order of steps shown in FIG. 4 is not intended to be limiting.

At step 402, position and orientation data are obtained from a first sensor positioned on the tongue of a subject. Subsequently, at step 404 lip movement data is optionally obtained from a pair of second sensors positioned on the lips of the subject. These steps of process 400 are generally the same as, or equivalent to, steps 302 and 304 (respectively) of process 300; thus, for the sake of brevity, details of these steps are not repeated herein.

At step 406, phoneme data is generated from the position and orientation data, and optionally the lip movement data, which is collectively referred to herein as “articulation data.” In particular, the articulation data is provided as an input to an articulation conversion model (e.g., articulation conversion model 112, as described above), which first generates phonemes (e.g., one or a series of phonemes) from the articulation data. As mentioned above, the articulation conversion model may include one of an HMM-DNN, HMM-GMM, LSTM-RNN, or other suitable AI model or combination of AI models. For example, the articulation conversion model may be a type of audio speech recognition model that has been adapted to accept articulation data as an input (e.g., which is typically a smaller number of dimensions than an audio input). In another example, the articulation conversion model may be a type of classifier. Notably, in the specific implementation of process 400, the articulation conversion model is trained and/or configured to convert articulation data into phonemes before generating synthesizable sound or speech data.

At step 408, synthesizable sound or speech data is generated from the phoneme data. In some implementations, the synthesizable sound or speech data is generated by the same model that generates the phoneme data, but it should be appreciated that a second AI model or other suitable model may be used to convert the phoneme data to synthesizable sound or speech data. In some implementations, the phoneme data is converted to synthesizable sound or speech data by first identifying words and/or phrases and then generating linguistic or acoustic features. In other implementations, the phoneme data is used to directly generate acoustic features.

At step 410, the synthesizable sound or speech data is output as audio or text. Specifically, in some implementations, the synthesizable sound or speech data is used to generate an audio output that, when emitted by a speaker, is perceivable as speech. In some such implementations, a vocoder may be used to further convert the synthesizable sound or speech data to a waveform. In some implementations, the synthesizable sound or speech data is displayed as text, e.g., on a user interface. For example, the text could be displayed via the user's smartphone.

### Method of Operation—Motion-to-Text-to-Speech

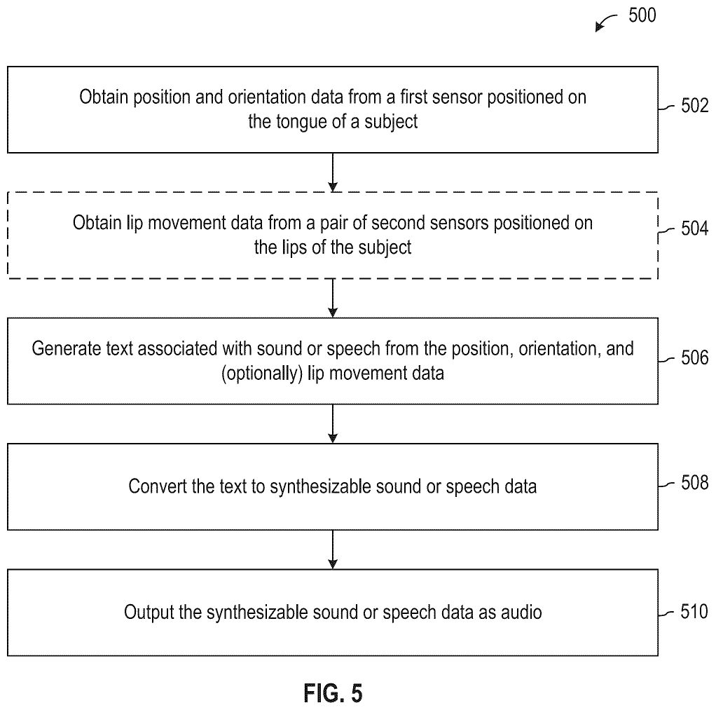

Referring now to FIG. 5, a flow chart of yet another process 500 for converting articulation data (e.g., tongue and/or lip motion) into synthesizable sound or speech is shown, according to some implementations. In particular, process 500 generally describes a technique of converting articulation data into text and then converting the text into synthesizable sound or speech, as discussed above. In this regard, process 500 can be implemented by system 100 and/or, more specifically, by controller 102 as described above. However, in some implementations, certain steps of process 500 are performed by an external device (e.g., remote device 130) upon receiving data from controller 102. It will be appreciated that certain steps of process 500 may be optional and, in some implementations, process 500 may be implemented using less than all of the steps. It will also be appreciated that the order of steps shown in FIG. 5 is not intended to be limiting.

At step 502, position and orientation data are obtained from a first sensor positioned on the tongue of a subject. Subsequently, at step 504 lip movement data is optionally obtained from a pair of second sensors positioned on the lips of the subject. These steps of process 500 are generally the same as, or equivalent to, steps 302 and 304 (respectively) of process 300; thus, for the sake of brevity, details of these steps are not repeated herein.

At step 506, text is generated from the position and orientation data, and optionally the lip movement data, which is collectively referred to herein as “articulation data.” In particular, the articulation data is provided as an input to an articulation conversion model (e.g., articulation conversion model 112, as described above), which first generates text associated with and/or representative of speech or sound. As mentioned above, the articulation conversion model may include one of an HMM-DNN, HMM-GMM, LSTM-RNN, or other suitable AI model or combination of AI models.

At step 508, synthesizable sound or speech data is generated from the text. In this regard, a text-to-speech converter may be used to convert the generated text into synthesizable sound or speech data. The text-to-speech converter (e.g., text-to-speech converter 114) may be any suitable AI model. In some such implementations, the text-to-speech converter may extract linguistic features from the generated text and then may additionally generate acoustic features from the extracted linguistic features.

At step 510, the synthesizable sound or speech data is output as audio or text. Specifically, in some implementations, the synthesizable sound or speech data is used to generate an audio output that, when emitted by a speaker, is perceivable as speech. In some such implementations, a vocoder may be used to further convert the synthesizable sound or speech data to a waveform. In some implementations, the synthesizable sound or speech data is displayed as text, e.g., on a user interface. For example, the text could be displayed via the user's smartphone.

### Example Sound or Speech Outputs

This disclosure contemplates that sound or speech outputs generated using the methods detailed herein can be developed using various sources and techniques. In some embodiments, the output synthesizable sound or speech data is generated using a model that is trained using recorded speech obtained from the patient and/or one or more other target individuals (e.g., relatives, friends, individuals with similar voices). In some implementations, a sound or speech output (e.g., a patient's voice) can be implemented by using a standard voice, such as the voice used in the articulation conversion models described in connection with FIGS. 2A-2B or the text-to-speech converter-based synthesis described in connection with FIG. 2C.

In some implementations (e.g., the example shown in FIG. 2C) voice training data is collected from a speaker with typical speech. In such examples, the output voice of the patient generated may sound like the voice of the speaker with typical speech. The source of the standard voice will be unknown to users/patients. There may be multiple standard voices (male or female, different dialects) for the users/patients to choose from. The voice training data can be recorded using a standard computer microphone, a wearable EMA device, or any device suitable for obtaining high quality audio data. In other implementations, the patient's own presurgical voice samples or voice samples from his/her family members or relatives can be used, if available. Candidate laryngectomees are, sometimes, suggested to record some presurgical voice samples by surgeons, nurses, or speech-language pathologists. Some patient's family members (e.g., twin brother, father, son), or relatives may have identical or highly similar voices. This disclosure contemplates that voice samples from family members or relatives can be used to drive the speech synthesis. In other implementations, users/patients can select a voice from a publicly available voice bank (voice samples donated from typical speaker from different regions in a country or the world), and then drive the speech synthesis using the matched or preferred voice. In any of these aforementioned implementations, the patients will have speech output with high voice quality (similar to typical speech). In the second scenario (with the availability of the patient's own presurgical voice samples or family member or a relative's voice samples), the speech output will closely resemble the patient's own voice.

With reference to FIG. 1, training voice data can be used to train an articulation conversion model 112 and/or a text-to-speech converter 114 (see also step 306 in FIG. 3, step 408 in FIG. 4, and step 508 in FIG. 5, discussed in more detail below). For the use of the training voice in an articulation-to-speech model training, in some implementations, both the articulatory (tongue and lip motion) data and the audio data from the typical speaker(s) will be used. Both the articulatory and audio data from a typical speaker can be first time-aligned to the patient's articulatory and audio data. This step is to make sure the duration and speaking rate are consistent from the training speaker (typical speaker) and target speaker (patient). In other implementations, only the audio data from a typical speaker is used, where the training audio data from the patient is replaced by the synthesized audio data that is based on the speech/voice of the typical speaker to train the articulation conversion model. In other implementations, only the audio data from a typical speaker is used to train the articulation conversion model (e.g., phenome-to-speech model or text-to-speech converter).

### Experimental Results and Additional Examples

To validate the use and operation of system 100 for SSI, various SSR experiments were conducted. However, before the SSR experiments, the articulation data collected from system 100 was directly compared with a commercial EMA. Then two experiments were conducted: isolated vowel recognition (consonant-vowel-consonant (CVC) classifications on eight English vowels) and continuous SSR. The vowel recognition used support vector machines (SVMs) as the classifiers with data collected from two male subjects using system 100. The experimental results were measured by classification accuracies and compared with previous results. The continuous SSR experiments used data collected from two different male subjects using system 100. The performance of two hybrid speech recognizers, GMM-HMM and DNN-HMM, was compared based on phoneme error rates (PERs). In addition, one of the subjects was tested using a commercial EMA with the same speech stimuli. A comparison between system 100 and the commercial EMA data from the same subject was performed in the continuous speech recognition experiment.

Setup: Data was collected using system 100 from four subjects, who were asked to speak at their normal pace and loudness. From two of the participants (subjects 1 and 2), isolated vowel data was collected with system 100). From the other two participants (subjects 3 and 4), continuous speech data collection was performed. As mentioned, commercial EMA data was also collected from one of the participants (subject 4).

For the isolated vowel data, eight English vowels in CVC syllables (/bab/, /bib/, /beb/, /bæb/, /æ/, / [symbol] /, /bob/, and /bub/) were used as vowel stimuli. These CVC syllables are referred to herein as “isolated vowels” (rather than isolated CVCs) because they have the same consonant context and also for simplicity. For continuous speech recognition, two phrase lists were used as the stimulus. One phrase list includes a total of 732 phrases. The first 132 phrases in the list were selected from phrases that are frequently spoken by the users of augmentative and alternative communication devices. Then, 600 additional phrases were added, which included sentences frequently used in daily communication. The other stimuli were a phoneme-balanced list of 700 sentences.

Procedure: During setup of system 100, a first sensor (e.g., tongue sensor 120) was attached to the tongue tip with dental glue. In particular, the first sensor was positioned on the tongue tip, approximately 1 cm from the apex of the tongue. As discussed above with respect to tongue sensor 120, the first sensor returns raw magnetic data (3D), positional data (3D), and orientational data (2D). The 3D positional data includes left-right (x), superior-inferior (y), and anterior-posterior (z) dimensions. Tongue motion and speech audio were recorded synchronously. The sampling rate of articulation data was 250 Hz.

For the commercial EMA device used in this study for comparison, articulation movement and the speech audio were also recorded synchronously. The 3D positional (xyz) and 3D quaternion (rep-resenting roll and pitch) signals were captured by each of the sensors (sampling rate=100 Hz). Consistent with system 100, 3D positional data include left-right (x), superior-inferior (z), and anterior-posterior (y) dimensions. Four sensors for the commercial EMA were attached to the tongue tip (5-10 mm to tongue apex), tongue back (20-30 mm back from tongue tip), middle of the upper lip, and lower lip. Only data from the tongue tip was used in this study for a comparison with system 100.

Direct Comparison of Trajectories: First, a direct comparison on the tongue tip trajectories of the commercial EMA and system 100 was performed. Here, only y and z dimensions (superior-inferior and anterior-posterior) were considered, as they are more significant in speech production. A nonlinear alignment technique, dynamic time warping (DTW), was used to align the data (same stimuli) in this experiment. First, the mean of each dimension was subtracted. Then, DTW was first applied to the parallel (same stimuli) EMA and system 100 data samples from Subject 4. After DTW alignment, the Pearson correlations were computed on the two dimensions. A higher correlation value indicates higher similarity. Linear alignment was not utilized because the data was collected from two sessions and the starting points of these data samples are not consistent. Instead, manual segmentation (to indicate the real starting point of each data sample) was performed in the vowel classification experiment below. The manual adjustment of the starting points was not needed in the continuous SSR experiment because the algorithm will align them automatically.

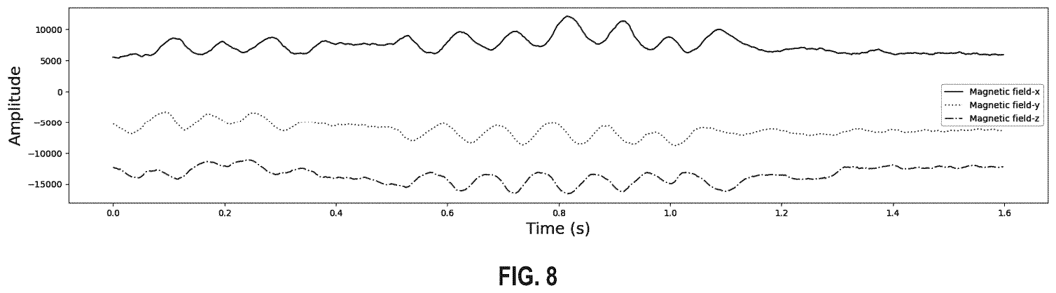

Besides the localized signals (spatial coordinates), raw magnetic signals are also provided by system 100, as discussed above. FIG. 8 shows an example of the raw magnetic signals obtained by the magnetometer of the first sensor (e.g., tongue sensor 120) for the following utterance: “I don't understand.” There is one magnetic output per axis, and this output is represented as a 16-bit value that measures the magnetic intensity. As mentioned above, magnetic measurements are fed into a machine learning model that predicts the spatial position and orientation of the sensor (x, y, z coordinates and orientations). As raw magnetic data are not provided in commercial EMAs, a comparison of the magnetic signals from system 100 and the commercial EMA could not be performed. Thus, the two experiments below were performed with and without using raw magnetic signals as input to determine the usefulness of the raw magnetic data when combined with positional and orientational data.

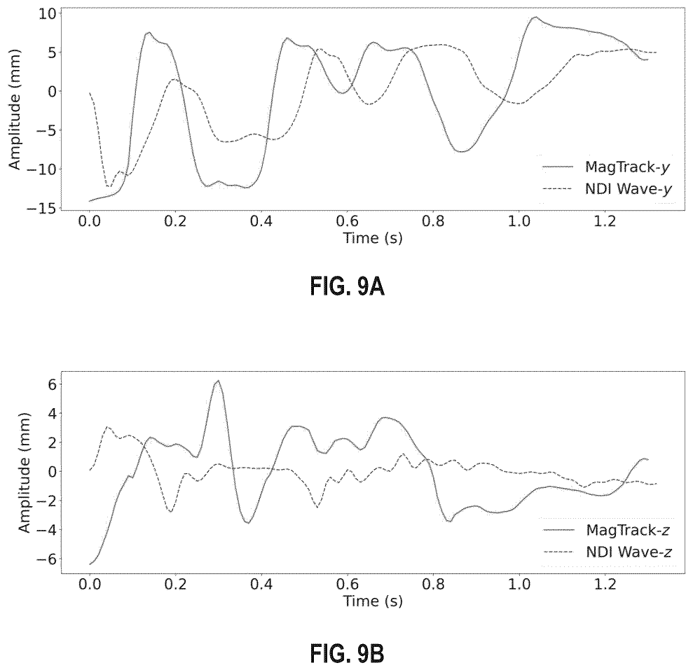

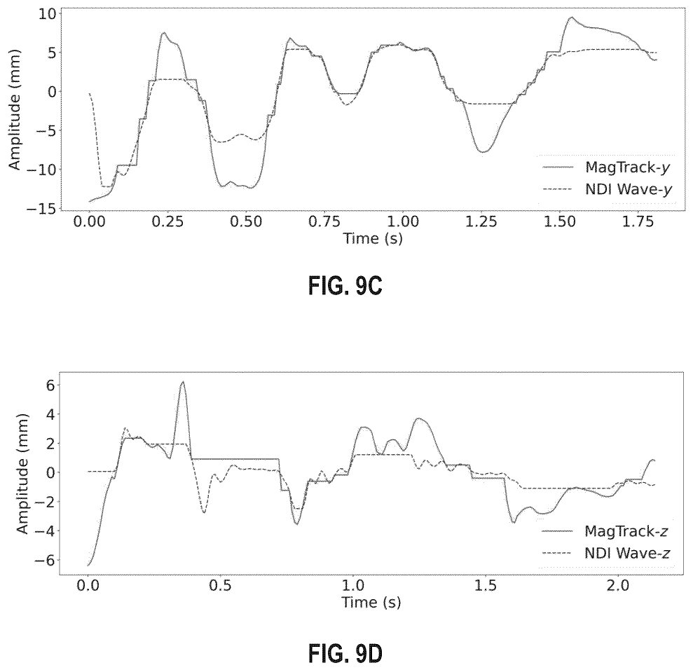

In the direct comparison experiment, the Pearson correlations between the data collected using system 100 and the commercial EMA after alignment with DTW were 0.72 and 0.63 for the superior-inferior (y) and anterior-posterior (2) dimensions, respectively. FIGS. 9A-9D show various examples of the tongue tip movement trajectories of Subject 4 when producing “I don't understand,” as captured by system 100 and the commercial EMA. Specifically, FIGS. 9A and 9B are the original tongue tip motion trajectories in y and z dimensions from system 100 and the commercial EMA, respectively. The tongue tip trajectory patterns from the two devices look similar, although the starting points are different (possibly due to session difference, as mentioned above). FIGS. 9D and 9D are DTW aligned trajectories for y and z dimensions, respectively, which visually demonstrate the high similarity of the tongue tip trajectories after the DTW alignment of data in FIGS. 9A and 9B, respectively.

Vowel Classification: Next, similar CVC classification experiments were conducted with an SVM. An SVM is a supervised machine learning algorithm that could be used for classification and regression. SVM classifiers “learn” by finding hyperplanes that best separate a data space. The support vectors are the data points that are closest to the hyperplanes. By employing kernel methods, SVM can also perform a nonlinear separation. As a non-deep learning algorithm, SVM has been demonstrated to be powerful, especially in some cases that are not suitable for deep learning models (e.g., insufficient training data). DNNs were explored in preliminary experiments but demonstrated lower performance, possibly due to the small size of data; thus, they were not used in this vowel classification experiment.

First, only the 2D positional signals (y and z without left-right direction) were used for comparison, then the x-direction position, orientation, and magnetic signals were added to explore the highest performance. The collected CVC data (e.g., by system 100) were manually parsed into clips of whole CVC syllables. Each of the CVC clips was down sampled to 10 frames to reduce feature dimension. Then, the concatenation of the 10 data points from each dimension (including x-y-z position, roll, pitch, magnetic, and their combinations) was used as the input of SVM (the maximum dimension is [3D position+2D orientation+3D magnetic]×10 data points=80D) for eight-class classification (/bab/, /bib/, /beb/, /bæb/, / [symbol] /, /b\hat{ }b/, /bob/, and /bub). The performance was measured by classification accuracies, which were computed by the number of correctly classified samples divided by the total number of samples, where a sample is a production of CVC. Five-fold cross-validation experiments were performed on each of the two subjects (Subjects 1 and 2). The whole data were first partitioned into five folds/parts. In each fold, one fifth of the data were used as testing data, and the rest were used as training data. The averaged accuracies over the five-fold were reported as the final performance.

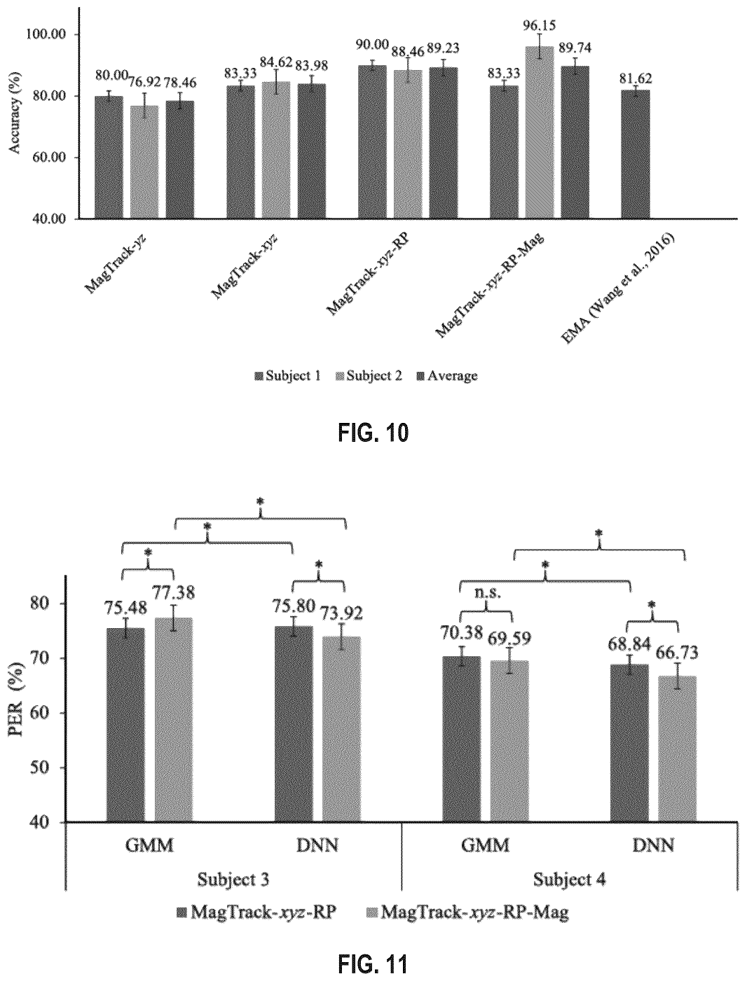

FIG. 10 illustrates the accuracies of vowel classification of Subjects 1 and 2. In particular, FIG. 10 shows accuracies using data from system 100 averaged from the two subjects in the isolated vowel recognition experiment, compared with the accuracy using a commercial EMA. Error bars indicate standard errors. For reference: “MagTrack-yz” refers to the accuracy using y-z (2D) positional data; “MagTrack-xyz” refers to the accuracy using 3D positional data; “MagTrack-xyz-RP” refers to the accuracy using 3D positional plus roll and pitch; and “MagTrack-xyz-RP-Mag” refers to the accuracy using raw magnetic data long with 3D positional and roll-pitch orientational data. The average accuracy is 78.46% when using 2D (y-z) positional information only, which was only slightly lower than the average accuracy of 81.6% achieved by the commercial EMA. When the x-dimension was used, the accuracy was increased to 83.98%, above that of the commercial EMA. After that, as the orientational and magnetic information was added, the accuracies were improved to 88.07% and 89.74%, which are also higher than the commercial EMA results.

Continuous SSR: As mentioned above, continuous SSR is used to recognize phoneme (or word) sequences from articulation speech data. In this study, phoneme-level recognition was performed since the phoneme sequence output is more convenient for the following text-to-speech stage in SSIs. All the sentences were first transcribed to phoneme sequences (39 unique phonemes and silence) based on the Carnegie Mellon University pronouncing dictionary. HMM-based automatic speech recognition models were utilized, as mentioned above, with two different speech recognizers: GMM-HMM and DNN-HMM. The speech recognizers adopted an HMM to model the temporal variations during speech, such as varying durations of the same phonemes. A single phoneme would be represented by a three-state left-to-right HMM (begin-middle-end subphones); the time variation of this phoneme would be modeled by intra- or interstate transition (stay in the same state or go to the next state). The GMM and DNN were used for modeling the probability distribution of the observed articulation signals (system 100 or commercial EMA data frames) given the current phonemes.

For the data captured using system 100, the input to the speech recognition models includes positional and orientational signals with or without raw magnetic signals included. The orientational information of system 100 includes the returned roll and pitch signals. In this experiment the input data from system 100 has a maximum dimension of 24. For the commercial EMA, the orientational information also includes roll and pitch, but was represented by the 3D quaternion. In this experiment, the input data from the commercial EMA were 18-dimensonal. The raw magnetic signals returned by system 100 were validated by comparing the experimental results with and without using them as input. All system 100 signals were down sampled to 100 Hz from 350 Hz to match the commercial EMA signals.

Performance was measured by the PERs, which were computed by the sum of insertion, deletion, and substitution errors divided by the number of the phonemes tested. Insertion recognition errors relate to the insertion of phonemes that do not exist in the ground truth phoneme sequences. Deletion errors relate to missing phonemes. Substitution errors occur when phonemes are mistakenly recognized as different ones. PER could be larger than 100% if there are too many insertion errors.

In order to leave sufficient testing (and training) data for satisfying phoneme distributions in each of the cross-validations, for Subject 3, five-fold cross-validation experiments were performed on the recorded 600 phrases (6,839 phonemes); each validation used 340 and 60 phrases for training and testing, respectively. For Subject 4 (732 System 100 and commercial EMA phrases, 8, 1124 phonemes), eight-fold cross-validation was performed in which, for each validation, the models were trained and validated on 678 phrases and tested with the remaining 54 phrases.

There are two types of representation of the phonemes to be recognized: monophone and triphone for HMM. For the monophone representation, three HMM states were used to represent each non-silence phoneme (begin, middle, and end) and five states were used to represent silence. For the triphone representation, decision tree-based clustering was used to find the optimal triphone combinations given the data set; each tri-phone was represented by a three-state HMM. As mentioned above, different stimuli were used for Subjects 3 and 4. The total number of triphones for Subject 3 is 1020, since the stimuli used were highly phoneme-balanced. The triphone number for Subject 4 used 128 triphones, since the stimuli used were from daily communication. These numbers of triphones are also the output dimension of the speech recognizer (number of classes to classify).

The language model used in this study is the Bigram language model, which gives the probabilities of current phonemes given the previous phoneme. A summarized parameter setup in the speech recognition is shown in Table 1.

TABLE 1
Articulation Movement

| | |
|---|---|
| MagTrack | With magnetic signals: position (3-dim) + |
| | orientation (2-dim) + magnetic (3-dim) + Δ + ΔΔ = |
| | 24-dim Without magnetic signals: position (3- |
| | dim) + orientation (2-dim) + Δ + ΔΔ = 15-dim |
| EMA | Position (3-dim) + quaternion (3-dim) + Δ + |
| | ΔΔ = (18-dim) |
| Sampling rate | MagTrack: 100 Hz (down-sampled from 350 Hz) |
| | EMA: 100 Hz |

GMM-HMM Topology

| | |
|---|---|
| Monophone | 122 states (39 phones × 3 + 5 for silence) |
| | 1,000 Gaussians |
| Triphone | 128 states (732-list) 1020 states (700-list) |
| | 7,000 Gaussians |
| Training method | Maximum likelihood estimation (MLE) |

DNN-HMM topology

| | |
|---|---|
| No. of nodes | 812 nodes for each hidden layer |
| Depth | 1-6 depth hidden layers |
| Training method | RBM pretraining, back-propagation |
| Input | 9 frames at a time (4 previous + current + 4 |
| | succeeding frames) |
| Input layer | 316 (9 × 24-dim MagTrack with magnetic signal) |
| dimension | 135 (9 × 15-dim MagTrack w/o magnetic signal) |
| | 162 (9 × 18-dim EMA) |
| Output layer | Monophone: 122 Triphone: 1020 (Subject 3) |
| dimension | Triphone: 128 (Subject 4) |
| Language model | Bi-gram phone/word language model |

FIG. 11 shows the PERs of continuous SSR using data collected using system 100 from Subjects 3 and 4. Here, both GMM and DNN models were used with or without magnetic signals. Unlike accuracy, a lower PER indicates a higher performance. One-way analysis of variance (ANOVA) testing results showed that there was a statistical significance between at least two groups for both Subject 3, F(2, 2)=3.33, p=0.046*, and Subject 4, F(2, 2)=3.81, p=0.021*(significant results are marked with an asterisk). Table 2 provides the two-tailed t-test results for selected comparisons under different experimental setups (using GMM or DNN with or without using magnetic data) from the same subjects. Generally, including the magnetic signals (shown in FIG. 11) resulted in higher performance (lower PERs) than in testing without using magnetic signals, except Subject 3 using the GMM model. The improvement of using magnetic signals in GMM for Subject 4 is not significant (see Table 2). When comparing the two models, DNN outperformed GMM both with and without using magnetic signals, except for Subject 3 without magnetic signals. For both subjects, the best results were achieved using DNN with magnetic signals.

TABLE 2

| Comparisons | Subject 3 | Subject 4 |
|---|---|---|
| With Mag vs. | t(8) = 5.37, p = .006* | t(14) = −1.87, p =.1 |
| without Mag (GMM) | d = 1.03 | d = 0.39 |
| With Mag vs. | t(8) = −3.75, p = .02* | t(14) = −4.71, p = .002* |
| without Mag (DNN) | d = 1.16 | d = 0.84 |
| GMM vs. DNN | t(8) = 7.35, p = .002* | t(14) = 6.06, p = .0005* |
| (with Mag) | d = 2.09 | d = 1.25 |
| GMM vs. DNN | t(8) = −3.75, p = 02* | t(14) = 2.78, p = .03* |
| (without Mag) | d = 0.18 | d = 0.68 |

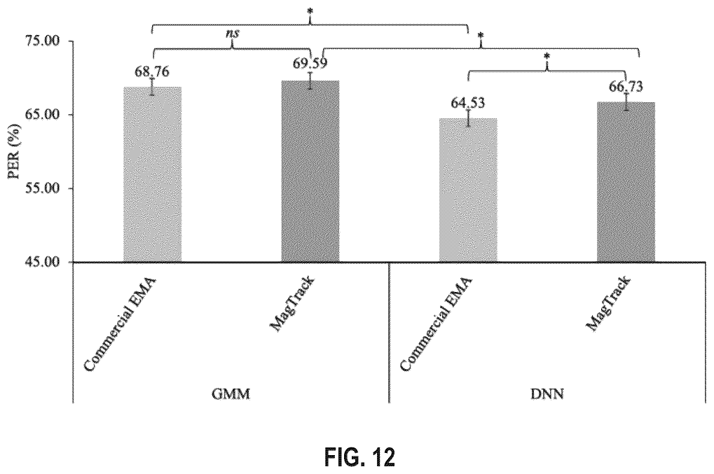

FIG. 12 shows the PERs of continuous speech recognition using GMM and DNN with data captured using system 100 (e.g., x-y-z coordinates, orientation, and magnetic signals) and commercial EMA (x, y, z coordinates and orientation signals only, as magnetic data were not available) from the same participant (Subject 4). One-way ANOVA tests showed there was a statistical significance between at least two groups, F(2, 2)=8.55, p=0.0003*. Table 3 shows two-tailed t-test results for selected comparisons under different experimental setups (using GMM or DNN with system 100 or commercial EMA data). The PERs from the commercial EMA were generally lower than those from system 100, although the difference was not statistically significant when using GMM (see Table 3). When comparing the two models, DNN statistically outperformed GMM.

TABLE 3

| Comparisons | Subject 4 |
|---|---|
| MagTrack vs. commercial | t(14) = 1.33, p = .22 d = 0.44 |
| EMA (GMM) | |
| MagTrack vs. commercial | t(14) = 7.30, p = .0002* d = 0.89 |
| EMA (DNN) | |
| GMM vs. DNN (MagTrack) | t(14) = 6.06, p = .0005* d = 1.25 |
| GMM vs. DNN (commercial | t(14) = 7.01, p = .0002* d = 2.04 |
| EMA) | |

Table 4 gives the percentages of different types of errors (e.g., substitution, deletion, and insertion errors) of the DNN-HMM experiment on Subject 4. Substitution and deletion errors dominated the errors consistently across different experimental setups (using different input data).

TABLE 4

| | PER | Substitution | Deletion | Insertion |
|---|---|---|---|---|
| Experiment | (%) | (%) | (%) | (%) |
| EMA-xyz-RP | 64.53 | 26.24 | 36.53 | 1.76 |
| MagTrack-xyz- | 68.84 | 28.50 | 38.23 | 2.11 |
| RP | | | | |
| MagTrack-xyz- | 66.73 | 28.71 | 35.68 | 2.34 |
| RP-Mag | | | | |
| Average | 66.70 | 27.82 | 36.81 | 2.07 |

Table 5 lists the occurrences of the 10 most frequent specific substitution, deletion, and insertion errors of the DNN-HMM experiment on Subject 4. The most common substitution error observed was the voiced stop/d/being substituted by the voiceless stop/t/across various speech recording setups. The most common deletion error was the deletion of silence, which was also consistent across all setups. The most common insertion error was/ih/when using EMA data and system 100 data with magnetic signals. Instead, the most insertion error was/ah/when using data from system 100 without magnetic signals.

TABLE 5

| | | | | | |
|---|---|---|---|---|---|
| Sub | Num | Ins | Num | Del | Num |

EMA-xyz-RP

| | | | | | |
|---|---|---|---|---|---|
| d ⇒ t | 49 | ih | 13 | sil | 725 |
| t ⇒ n | 32 | ah | 12 | ah | 335 |
| d ⇒ n | 26 | n | 11 | ih | 300 |
| t ⇒ d | 25 | b | 7 | n | 195 |
| ah ⇒ ih | 21 | dh | 6 | t | 185 |
| ao ⇒ aa | 19 | f | 5 | d | 147 |
| r ⇒ er | 17 | w | 4 | iy | 128 |
| z ⇒ s | 15 | aa | 3 | m | 119 |
| ah ⇒ aa | 14 | ch | 2 | k | 110 |
| iy ⇒ ih | 13 | g | 1 | eh | 106 |

MagTrack-xyz-RP

| | | | | | |
|---|---|---|---|---|---|
| d ⇒ t | 39 | ah | 16 | sil | 684 |
| t ⇒ d | 27 | n | 15 | ah | 337 |
| n ⇒ d | 18 | ih | 14 | n | 328 |
| ah ⇒ ae | 17 | ac | 12 | t | 324 |
| z ⇒ s | 16 | t | 9 | ih | 170 |
| ih ⇒ iy | 14 | d | 8 | d | 150 |
| ah ⇒ uw | 13 | hh | 7 | m | 122 |
| t ⇒ dh | 12 | sil | 5 | k | 111 |
| t ⇒ n | 11 | ey | 4 | ay | 106 |
| ah ⇒ ow | 10 | f | 3 | ae | 100 |

MagTrack-xyz-RP

| | | | | | |
|---|---|---|---|---|---|
| d ⇒ t | 39 | ah | 16 | sil | 684 |
| t ⇒ d | 27 | n | 15 | ah | 337 |
| n ⇒ d | 18 | ih | 14 | n | 328 |
| ah ⇒ ae | 17 | ae | 12 | t | 324 |
| z ⇒ s | 16 | t | 9 | ih | 170 |
| ih ⇒ iy | 14 | d | 8 | d | 150 |
| ah ⇒ uw | 13 | hh | 7 | m | 122 |
| t ⇒ dh | 12 | sil | 5 | k | 111 |
| t ⇒ n | 11 | ey | 4 | ay | 106 |
| ah ⇒ ow | 10 | f | 3 | ae | 100 |

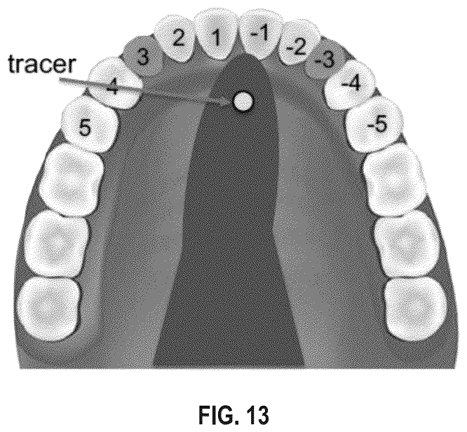

Tongue-Teeth Contact: FIG. 13 shows a diagram of a tongue-teeth contact detection experiment that was also conducted to test system 100, according to some implementations. This experiment involved a subject contacting/tapping their upper teeth with their tongue while a tongue sensor (e.g., one of tongue sensor(s) 122) was attached to the tongue. For a single subject, 100 samples were recorded when tapping each of the upper teeth sequentially, as shown. 30 samples were collected for other states. The experiment was conducted as a 10-fold-cross-validation experiment and found that system 100 could detect which tooth was being contacted/tapped with nearly 100% accuracy.

Discussion: The direct comparison experiment clearly demonstrated the similarity of the tongue tip trajectories captured by the two devices via moderate-to-strong Pearson correlations (after DTW alignment). In addition, FIGS. 9A-9D visually illustrate the similarity of the trajectories (before and after aligned). These results suggested that system 100 is suitable for general speech articulation studies.

For vowel recognition tasks, positional data from system 100 demonstrates slightly lower performance than commercial EMAs under the same data setup (using y and z position only) due to the lower localization accuracies. As the other information was added (x position, orientation, and magnetic), the accuracies could be higher than a commercial EMA. In addition, it is surprising that adding x-axis improved performance here as it has previously been suggested that x-dimension (lateral movement) is not significant at least in typical speech production. One possible explanation may be that machine learning is able to find subtle pattern differences that these conventional approaches could not detect. Through the experiments described herein, it was found that the x-dimension could be significant in dysarthric speech due to amyotrophic lateral sclerosis.

For continuous SSR, the PERs are high compared to those from audio speech recognition, which is not surprising. Audio speech recognition could achieve lower than 10% PER because of rich information in the acoustics and larger data size. Particularly, SSR lacks acoustic information that helps distinguish voiced and unvoiced phonemes. As indicated in Table 4, deletion and substitution errors dominated the errors, which was likely due to lack of phonation information. Specifically, as shown in Table 5, most substitution errors occurred in consonant cognates (voiced and voiceless consonant pairs, e.g., /d/ and /t/). Deletion of the silence also contributed a significant portion of the recognition errors likely for the same reason. These errors are expected to be reduced at the word- or sub-word-level recognition since more contextual information can be embedded in the recognition tokens (words or sub-words).

In general, the results of continuous speech recognition experiment on the data from both of the subjects are promising, although Subject 4 performed better than Subject 3 (see FIG. 10). This is possibly due to the smaller data set from Subject 3 (600 phrases) compared to that from Subject 4 (732 phrases). In addition, different stimuli were used. The 732-phrase list used by Subject 4 was chosen from daily used sentences, whereas the phrase list used by Subject 3 was more phoneme balanced, which led to more triphones (1020 for Subject 3 compared to 128 for Subject 4; see the details in Table 1). When comparing the commercial EMA and system 100 (with magnetic signals included), the commercial EMA outperformed system 100 by only 0.83% and 2.2% in GMM and DNN, respectively (see FIG. 12).

Although the experiments described herein focused on the validation of the potential of applying system 100 in SSI, system 100 has a number of other potential applications. For example, system 100 could be adapted for tongue-controlling rehabilitation applications such as tongue-controlling wheelchairs. Other speech applications include basic and clinical speech kinematic studies, visualization-based speech therapies, and second language learning. For example, previous studies have found that the tongue tip and tongue dorsum act more independently for more anterior consonantal productions. It has also been suggested that visual biofeedback can facilitate speech production training in clinical populations and second language learners in their study. In addition, previous studies indicate that articulation data could improve dysarthric speech recognition when articulation information was added on top of acoustic input. With system 100, articulation information can be conveniently provided as a supplementary information source for dysarthric speech recognition.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, abut for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A system for generating synthesized sound or speech, the system comprising:
a sensor positioned on a user's tongue to generate position data and orientation data associated with a position and orientation of the user's tongue;
one or more processors; and
memory having instructions stored thereon that, when executed by the one or more processors, cause the system to:
receive the generated position data and orientation data from the sensor;
generate, via an articulation conversion model, synthesizable sound or speech data using the generated position data and orientation data; and
output the synthesizable sound or speech data as at least one of: (i) audio of synthesized voice or speech, or (ii) a textual representation of the synthesizable sound or speech data.

2. The system of claim 1, wherein generating the synthesizable sound or speech data includes to:
generate phoneme data from the generated position data and orientation data; and
convert the phoneme data to the synthesizable sound or speech data.

3. The system of claim 1, wherein generating the synthesizable sound or speech data includes to:
generate text associated with sound or speech from the generated position data and orientation data; and
convert the text to the synthesizable sound or speech data using a text-to-speech conversion model.

4. The system of claim 1, wherein the articulation conversion model comprises a Gaussian mixture model (GMM) combined with a hidden Markov model (HMM) or a deep neural network (DNN) combined with a hidden Markov model (HMM).

5. The system of claim 1, wherein the articulation conversion model comprises a long short-term memory (LSTM) recurrent neural network (RNN).

6. The system of claim 1, wherein the position data comprises left-right (x), superior-inferior (y), and anterior-posterior (z) coordinates.

7. The system of claim 1, wherein the orientation data comprises pitch and roll.

8. The system of claim 1, wherein the sensor comprises an inertial measurement unit (IMU), wherein the position data is three-dimensional and the generated orientation data is two-dimensional.

9. The system of claim 1, wherein the sensor is further configured to detect three-dimensional (3D) magnetic field signals based on detected variations in a local magnetic field corresponding to movement of the tongue, wherein the instructions further cause the system to:
convert the 3D magnetic field signals into additional 3D position information and additional 2D orientation information; and
augment the position data and the orientation data with the additional 3D position information and the additional 2D orientation information for generating the synthesizable sound or speech data.

10. The system of claim 1, further comprising a pair of second sensors positioned on the user's lips to generate lip movement data by tracking movement of the lips, wherein the instructions further cause the system to:
receive the lip movement data from the pair of second sensors, and wherein the synthesizable sound or speech data is generated using lip movement data in addition to the generated position data and orientation data.

11. A method for generating synthesized sound or speech, the method comprising:
obtaining, from a sensor positioned on a tongue of a user, position data and orientation data associated with a position and orientation of the tongue,
generating, via an articulation conversion model, synthesizable sound or speech data using the generated position data and orientation data; and
outputting the synthesizable sound or speech data as at least one of: (i) audio of synthesized voice or speech, or (ii) a textual representation of the synthesizable sound or speech data.

12. The method of claim 11, wherein generating the synthesizable sound or speech data includes:
generating phoneme data from the generated position data and orientation data; and
converting the phoneme data to the synthesizable sound or speech data.

13. The method of claim 11, wherein generating the synthesizable sound or speech data includes:
generating text associated with sound or speech from the generated position data and orientation data; and
converting the text to the synthesizable sound or speech data using a text-to-speech conversion model.

14. The method of claim 11, wherein the output synthesizable sound or speech data is generated using a model that is trained using recorded speech obtained from the user and/or one or more other target individuals.

15. The method of claim 11, wherein the articulation conversion model comprises one of: (i) a Gaussian mixture model (GMM) combined with a hidden Markov model (HMM), or (ii) a deep neural network (DNN) combined with a hidden Markov model (HMM).

16. The method of claim 11, wherein the articulation conversion model comprises a long short-term memory (LSTM) recurrent neural network (RNN).

17. The method of claim 11, wherein the position data comprises left-right (x), superior-inferior (y), and anterior-posterior (z) coordinates, and the orientation data comprises pitch and roll.

18. The method of claim 11, wherein the sensor comprises an inertial measurement unit (IMU), wherein the position data is three-dimensional and the generated orientation data is two-dimensional.

19. The method of claim 18, wherein the sensor is further configured to detect three-dimensional (3D) magnetic signals based on detected variations in a local magnetic field corresponding to movement of the tongue, the method further comprising:
converting the 3D magnetic signals into additional 3D position information and additional 2D orientation information; and
augmenting the position data and the orientation data with the additional 3D position information and the additional 2D orientation information for generating the synthesizable sound or speech data.

20. The method of claim 11, further comprising:
obtaining, from a pair of second sensors positioned on the user's lips, lip movement data associated with movement of the lips, wherein the synthesizable sound or speech data is generated using lip movement data in addition to the generated position data and orientation data.
